(19) United States
(12) Patent Application Publication
(10) Pub. No.: US 2026/0316572 A1
(43) Pub. Date: Oct. 15, 2026

(54) GENERATING ARTIFICIAL INTELLIGENCE (AI) CONTENT BASED ON PREDICTED HANDOVER TIME

(71) Applicant: Toyota Motor Engineering & Manufacturing North America, Inc., Plano, TX (US)

(72) Inventors: Dawei Chen, Milpitas, CA (US); Yitao Chen, Sunnyvale, CA (US); Qi Chen, San Jose, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/174,032

(22) Filed: Apr. 9, 2025

(51) Int. Cl. B60K 35/85; G06F 9/50; G06N 20/00

(52) U.S. Cl. CPC B60K 35/85; G06F 9/5055; G06N 20/00; B60K 2360/592

(57) ABSTRACT

Systems, methods, and other embodiments described herein relate to managing a handover of artificial intelligence (AI) content generation to an edge server. In one embodiment, a method includes receiving a request to hand over AI content generation to a second edge server. The AI content is based on generative AI input data from a vehicle AI agent. The method also includes extracting context data for a handover. The context data indicates a vehicle state, a second edge server state, and a vehicle-server connection state. The method also includes predicting a handover time of the generative AI input data based on the context data. The method also includes distributing the generative AI input data based on a predicted handover time and presenting the AI content through the vehicle AI agent.

### TECHNICAL FIELD

The subject matter described herein relates, in general, to the generation of artificial intelligence (AI) content in vehicles and, more particularly, to handing off the AI content generation based on a predicted handover time of generative AI input data.

### BACKGROUND

Generative artificial intelligence (AI) systems can create new content (text, images, or videos) based on user input. A generative AI system may identify structures, patterns, and relationships in a training data set, which training data set may include hundreds, thousands, and even millions of instances of content. Once a request for AI content (e.g., images, text, or video) is received from a user, a generative AI system performs inference (i.e., the generation of new content) based on the received input and the identified structures, patterns, and relationships learned from the training data set.

Some vehicles include generative AI agents that generate AI content for in-cabin user experiences. For example, the vehicle AI agent may generate intuitive and interactive infotainment interfaces. As another example, a generative AI agent may generate a virtual companion/assistant (as a holographic projection, voice assistant, etc.) that interacts with an occupant of the vehicle (via voice, gesture, and/or touchscreen command), answer queries, and provide assistance, such as navigational assistance, to the occupants of the vehicle. While particular references are made to particular generative AI content and uses, the generative AI agent of a vehicle may generate other kinds of new content for engagement with an occupant of the vehicle.

### SUMMARY

In one embodiment, example systems and methods relate to a manner of improving the presentation of digital generative AI content in a vehicle.

In one embodiment, an AI handover system for efficiently handing over AI content generation to a best-suited entity is disclosed. The AI handover system includes a processor and a memory storing machine-readable instructions. The machine-readable instructions, when executed by the processor, cause the processor to receive a request to hand over AI content generation to a second edge server. The AI content is based on generative AI input data from a vehicle AI agent. The machine-readable instructions, when executed by the processor, also cause the processor to extract context data for a handover. The context data indicating a vehicle state, a second edge server state, and a vehicle-server connection state. The machine-readable instructions, when executed by the processor, also cause the processor to 1) predict a handover time of the generative AI input data based on the context data and 2) distribute the generative AI input data based on a predicted handover time. The machine-readable instructions, when executed by the processor, also cause the processor to present the AI content through the vehicle AI agent.

In one embodiment, a non-transitory machine-readable medium for efficiently handing over AI content generation to a best-suited entity and including instructions that, when executed by a processor, cause the processor to perform one or more functions is disclosed. The instructions include instructions to receive a request to hand over AI content generation to a second edge server. AI content is based on generative AI input data from a vehicle AI agent. The instructions also include instructions to extract context data for a handover. The context data indicating a vehicle state, a second edge server state, and a vehicle-server connection state. The instructions also include instructions to 1) predict a handover time of the generative AI input data based on the context data and 2) distribute the generative AI input data based on a predicted handover time. The instructions also include instructions to present the AI content through the vehicle AI agent.

In one embodiment, a method for efficiently handing over AI content generation to a best-suited entity is disclosed. In one embodiment, the method includes receiving a request to hand over AI content generation to a second edge server. AI content is based on generative AI input data from a vehicle AI agent. The method also includes extracting context data for a handover. The context data indicating a vehicle state, a second edge server state, and a vehicle-server connection state. The method also includes 1) predicting a handover time of the generative AI input data based on the context data and 2) distributing the generative AI input data based on a predicted handover time. The method also includes presenting the AI content through the vehicle AI agent.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 depicts an environment where an AI handover system distributes generative AI input data based on a predicted handover time.

FIG. 2 depicts the generation of AI content between a vehicle AI agent and an edge server.

FIG. 3 illustrates one embodiment of a vehicle within which systems and methods disclosed herein may be implemented.

FIG. 4 illustrates one embodiment of an AI handover system that is associated with distributing generative AI input data based on a predicted handover time.

FIG. 5 illustrates a flowchart for one embodiment of a method that is associated with distributing generative AI input data based on a predicted handover time.

FIG. 6 illustrates one embodiment of a machine-learning AI handover system that is associated with distributing generative AI input data based on a predicted handover time.

FIG. 7 illustrates a flowchart for one embodiment of a method that is associated with distributing generative AI input data based on a predicted handover time.

FIGS. 8A – 8D depict the alteration of example AI content generation parameters.

### DETAILED DESCRIPTION

Systems, methods, and other embodiments associated with improving the generative artificial intelligence (AI) capabilities of a vehicle are disclosed herein. As previously described, vehicles may include generative AI systems, which create new content (text, images, or videos) based on user input. Various types of AI content may be produced, including in-cabin voice assistants and in-cabin holographic projections. These AI interfaces not only provide the vehicle occupants with requested information/assistance but may also do so intelligently by responding to particular situational contexts and user history. Thus, a vehicle-mounted generative AI system may enhance occupant experience by providing customized, innovative, immersive, and captivating in-cabin experiences.

However, generative AI tasks may be computationally expensive and complex and thus may take a long time to complete. The time to completion of certain AI tasks (i.e., the latency) by a vehicle-based generative AI system may not meet the latency criteria for some vehicle AI systems. For example, an AI navigational assistant may not be quick enough to provide AI-generated navigation instructions before the vehicle executes a navigational step. As another example, for text-to-image conversion, excess latency may frustrate a user, discouraging them from using the AI systems of the vehicle. That is, end-to-end latency may prevent vehicle-based generative AI from being implemented in different vehicles and/or used by vehicle occupants. An above-threshold latency may, therefore, reduce the effect of the in-cabin AI experience and thus frustrate the purpose of generative AI systems.

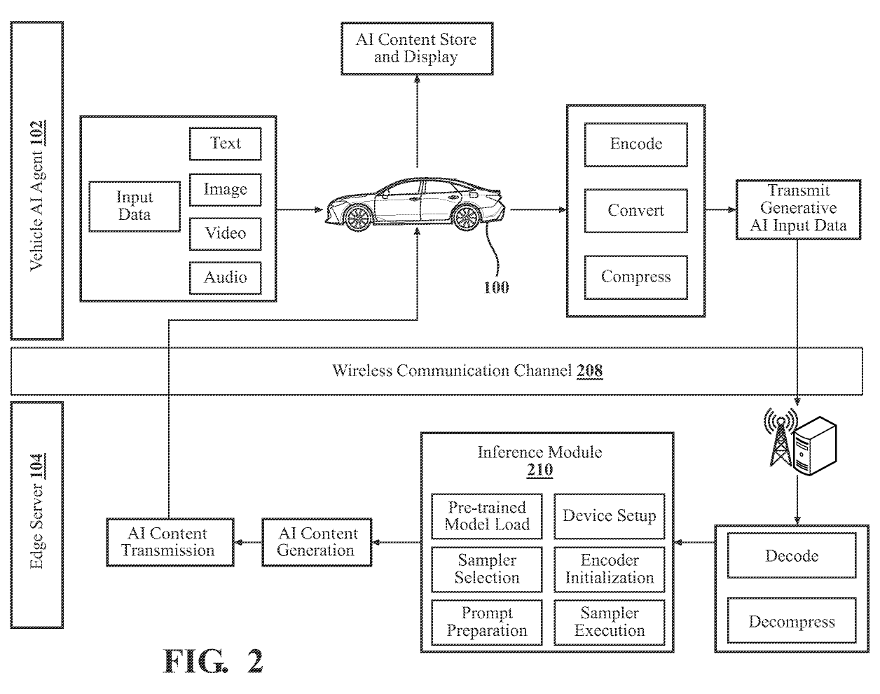

To address this issue, the present specification describes edge-assisted AI content generation where a portion of the generative AI tasks are offloaded to an edge server. In general, an edge server is a remote computing device with greater processing capability than a client device, such as the vehicle AI agent. As compared to a cloud server, an edge server may be closer to the vehicle, thus reducing the latency of transmission of generative AI input data from the vehicle to the processing entity and the latency of transmission of the AI content from the processing entity to the vehicle. As depicted below in FIG. 2, the vehicle AI agent may pre-process the input data and generate what may be referred to as generative AI input data. This generative AI input data may be transmitted to an edge server that performs AI inference, which refers to the generation of the AI content based on the generative AI input data. The edge server then transmits the AI content back to the vehicle for presentation through an in-cabin presentation system.

While edge assistance may reduce the latency of AI content generation, other complications may still be present when generating AI content in a moving object, such as a vehicle. For example, it may be that the vehicle travels from a coverage area of one edge server into another, without completing the generation of the AI content. In this example, the first and second edge servers may engage in service migration. During service migration, the intermediate results of AI generation (i.e., the partially generated AI content) are passed to the second edge server, which second edge server completes the AI content generation and transmission of the AI content to the target vehicle. This service migration may further exacerbate the latency between the receipt of a request for AI content and the generation and delivery of the AI content. This infers, of course, that there is a second edge server available. For example, it may be that the vehicle is exiting an area covered by a first edge server and is entering an area not covered by any other edge server. In this example, the vehicle may lose the capability of presenting in-cabin generative AI content.

Moreover, in some cases, a generative AI server relies not only on the currently received user input but also on historical usage patterns. That is, the AI content that is generated may be based not only on currently received user input but also on contextual data, such as past instances, preferences, and patterns of received user input. The transmission of this “session history” from edge server to edge server may further exacerbate generative AI content delivery latency.

Accordingly, the present specification describes an AI handover system that considers various latency factors and predicts a handover time for generative AI input data (i.e., a time to hand over the partially generated AI content, session history, etc., to an upcoming edge server). In an example, the AI handover system is a machine learning system that uses a myriad of inputs about the current context of a handover to predict the handover time. For example, the AI handover system acquires information about 1) the state of the vehicle (e.g., vehicle location, vehicle speed, predicted trajectory), 2) the state of a connection with the edge server to where the vehicle is driving (e.g., received signal strength and data transmission rate), and 3) the state of the upcoming edge server itself (e.g., an amount of available processing resources and a topology of the server network). The AI handover system generates a predicted handover time from this information and distributes the generative AI input data accordingly. That is, the AI handover system considers current state information and information about the movement of the vehicle to determine which entity (i.e., an existing edge server, the vehicle, or an upcoming edge server) should perform the AI content generation.

In this way, the AI handover system can handle edge-based computing requests within the dynamic environment of the vehicle. For example, as shown below, depending on the predicted handover time, the system can reject the request and process the generative AI input data at the vehicle, adapt the level of processing at a current edge server to minimize the delay and facilitate completion of the generative AI process before the vehicle leaves the coverage area of the current edge server, or migrate the request to an upcoming edge server along a route, etc.

In this way, the disclosed systems, methods, and other embodiments not only facilitate generative AI content generation for consumption in a vehicle but improve vehicle-based generative AI content delivery by determining which entity in an environment (i.e., the vehicle, a current edge server, or an upcoming edge server) is most capable of creating the new content. That is, rather than merely determining whether to generate AI content at a vehicle or whether to offload the generative AI content to an edge server, the present system determines whether to offload the generative AI content, how to offload the generative AI content, and to which device the generative AI input data should be transmitted. As described below, this determination may be based on the predicted handover time, coverage discontinuities between various edge servers, and the processing capabilities of the upcoming edge server.

As such, the present systems, methods, and other embodiments provide AI content through a vehicle AI agent when such content may otherwise be unavailable. For example, the present systems, methods, and other embodiments may facilitate the presentation of AI content when the vehicle is near the edge of a coverage area and may otherwise lose service. As another example, the present system may still facilitate AI interaction even when the processing resources of an edge server are low, albeit with potentially reduced quality and resolution. Still further, the present system facilitates AI content generation and presentation when a handover time is such that service may be interrupted or result in a latency that would otherwise detract from the AI experience.

As used herein, a “vehicle” is any form of transport that may be motorized or otherwise powered. In one or more implementations, the vehicle is an automobile. While arrangements will be described herein with respect to automobiles, it will be understood that embodiments are not limited to automobiles. In some implementations, the vehicle may be a robotic device or a form of transport that, for example, includes AI interfaces that interact with users to answer questions, provide assistance, or otherwise enhance the machine-to-human interaction and thus benefits from the functionality discussed herein associated with handing over AI generation tasks to different edge servers in a network of AI generating edge serves.

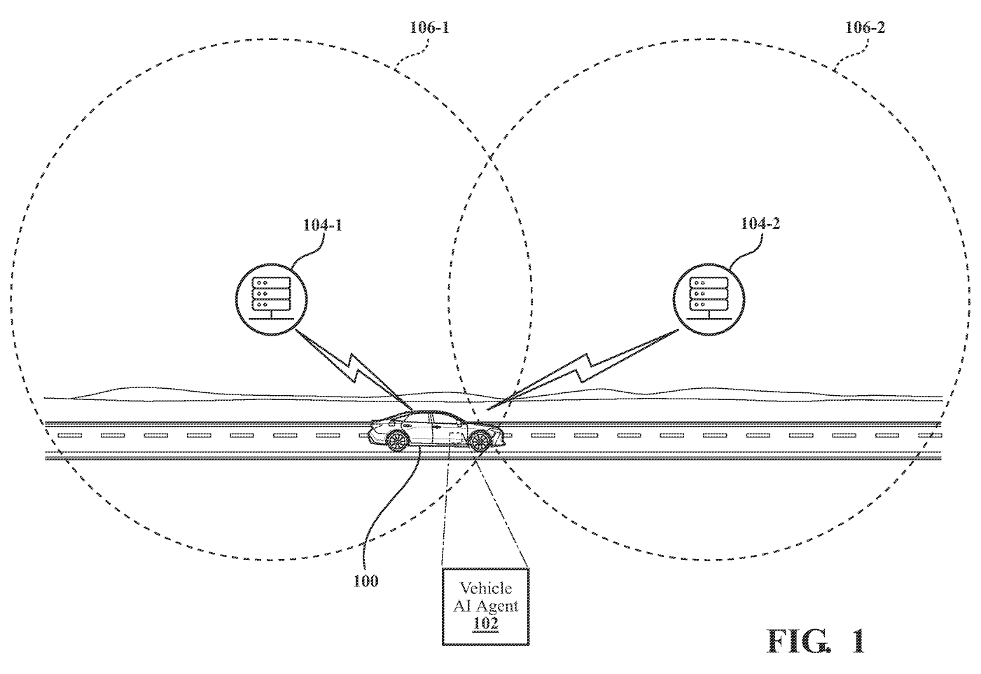

FIG. 1 depicts an environment where an AI handover system distributes generative AI input data based on a predicted handover time. As described above, it may be desirable to generate and present AI content in a vehicle 100. That is, the vehicle 100 may include an interface, whether visual or audible, where AI content is presented to an occupant of the vehicle 100. The vehicle AI agent 102 may be responsible, in part, for receiving input data on which the AI content is based and presenting the AI content through a vehicle system.

As described above, AI content may be new content, rather than retrieved or extracted content, that is generated based on user input. As described in greater detail below, the generative AI system may be a supervised system, where it is trained to recognize patterns, relationships, and data structures and generate an output based on such. Accordingly, when user input is received, the generative AI system, being trained on the training set, can generate content related to the received input due in part to the patterns, relationships, and structures identified through training.

The forms of AI content may vary. For example, in some cases, the AI content may be text. For example, a user may input a query or request for navigational instructions. In this example, the vehicle AI agent 102 may present text on a display screen. In another example, the AI content may be images or video. In this example, the vehicle AI agent 102 may present images or videos that provide the requested information rather than presenting response text. In another example, the AI content may be audible information, such as a replicated voice of a virtual assistant. In one particular example, the vehicle AI agent 102 may generate a holographic projection of the virtual assistant. While particular reference is made to particular AI content, the form of the AI content may vary.

As described above, generating AI content can be computationally expensive. Specifically, identifying patterns in the inputs and inferring new content based on them may consume large amounts of processing and memory resources. In some cases, the vehicle 100 may not include sufficient resources to generate the AI content. Accordingly, the vehicle AI agent 102 may offload data to a remote device, such as an edge server 104-1 and 104-2, which has more resources to generate the AI content. In general, an edge server 104-1 and 104-2 is a computing device with processing and memory resources and instructions that perform AI inference. Accordingly, vehicle 100 may include a communication system through which the generative AI input data may be offloaded to edge servers 104-1 and 104-2, which have more resources to generate complex AI content.

An edge server 104-1 and 104-2, as compared to a cloud server, may be located closer to the client, in this example, the vehicle AI agent 102 of the moving vehicle 100. That is, an edge server 104-1 and 104-2, as well as a cloud server, may both be remote computing systems; however, an edge server 104-1 and 104-2 may be closer to the end device (i.e., the vehicle AI agent 102 on the vehicle 100). This proximity may reduce the latency in generating AI content. That is to say, edge-assisted generative AI may exhibit less latency than cloud-assisted generative AI due to the closer proximity of the edge server 104-1 and 104-2 to the vehicle 100 than a cloud server. As described above, each edge server 104-1 and 104-2 may have a coverage area 106-1 and 106-2, which may be defined as a geographic region in which the respective edge servers 104-1 and 104-2 can provide the target service (i.e., generative AI content).

Providing AI content in a vehicle 100 may pose certain challenges. For example, vehicles 100 are not stationary. That is, a vehicle 100 may travel into and out of the coverage areas 106-1 and 106-2 of various edge servers 104-1 and 104-2. As an example, the coverage area 106-1 and 106-2 of a particular edge server 104-1 and 104-2 may have a radius of between 50 and 200 meters. However, the coverage areas of AI-generating edge servers 104-1 and 104-2 may be larger or smaller than the example range. It may be the case that the generative tasks may not be completed by one edge server (e.g., a first edge server 104-1) while the vehicle 100 is within the respective coverage area (e.g., the first edge server coverage area 106-1). Accordingly, as described above, the intermediate results or the partially completed AI content may be passed to a second edge server 104-2, which may have a coverage area 106-2 through which the vehicle 100 will pass as it travels along the road. As described, handing off these partially completed results may be time-consuming and add to the latency of delivering AI content. Moreover, while FIG. 1 depicts an overlap in the first edge server coverage area 106-1 and the second edge server coverage area 106-2, it may be that adjacent coverage areas 106-1 and 106-2 do not overlap, such that the vehicle 100 may find themselves in an area where edge-assisted AI content generation is unavailable. As described below, the present AI handover system may account for upcoming discontinuities, thereby allowing generative AI content in a vehicle 100.

FIG. 2 depicts the edge-assisted generation of AI content. As described above, the vehicle AI agent 102 initiates the creation and presentation of AI content, and the actual generation of the AI content may be performed by an inference module 210 of the edge server 104.

In an example, the triggering of the AI content generation may be based on user input or may be triggered automatically. For example, in-cabin sensors may detect a certain gesture, pose, or movement of an occupant, triggering the generation of AI content. In another example, vehicle sensors, which detect the movement of the vehicle 100, may trigger the generation of AI content. For example, a vehicle sensor may determine that a vehicle 100 is not slowing down for a turn prescribed in navigational instructions. In this example, the fact that the vehicle 100 is not slowing down for a prescribed turn may trigger the generation of an AI reminder.

In other examples, however, the trigger may be user input, which may be text input, image input, video input, or audio input. For example, a driver of the vehicle 100 may ask a question such as “Where is the nearest market?” In this example, the AI content may be a textual, audible, or visual presentation of the response.

Whatever the trigger, the vehicle AI agent 102 may preprocess the input data, which may include encoding, format conversion, and/or compression. For example, an input video may have a specific format, but the inference module 210 may process video files in a different format. In this case, the vehicle AI agent 102 may convert the source video into a format compatible with the inference module 210. Moreover, as depicted in FIG. 2, it may be the case that the generative AI input data is transmitted over a wireless communication channel 208. Accordingly, the generative AI input data may be compressed to reduce the bandwidth and/or duration of the transmission. Moreover, the generative AI input data may be encoded to protect the integrity and privacy of the data. While FIG. 2 depicts specific pre-processing operations, the vehicle AI agent 102 may perform other processing operations.

Following pre-processing, the vehicle AI agent 102 transmits the generative AI input data (e.g., the pre-processed input data and any metadata utilized by the inference module 210 in generating the AI content) to the edge server 104. In an example, this may be via a wireless communication channel 208, which wireless communication channel 208 may use a variety of wireless protocols such as Wi-Fi, dedicated short-range communication (DSRC), vehicle-to-everything V2X, global system for mobile communication (GSM), Enhanced Data Rates for GSM Evolution (EDGE), Long-Term Evolution (LTE), 5G, or another communication technology that provides for the vehicle AI agent 102 communicating with the remote edge server 104. In any case, the vehicle AI agent 102 may include a transceiver and can leverage various wireless communication technologies to provide communications with the edge server 104.

Upon receipt, the edge server 104 may process the generative AI input data, which may include decompressing the generative AI input data and/or decoding the generative AI input data. While FIG. 2 depicts specific processing operations, the edge server 104 may perform other processing operations.

The processed generative AI input data is then passed to an inference module 210, which performs AI inference. In general, AI inference is the process by which the edge server 104 generates the AI content based on 1) the generative AI input data and 2) predictions and patterns in the generative AI input data as determined by the inference module 210, which is trained on a training set of data.

In some examples, to generate the AI content, the inference module 210 may perform different operational steps, such as loading a pre-trained model, setting up a device, performing sampler selection, and encoder initialization. Additional example operations include prompt preparation and sampler execution. There are various types of inference modules, such as latent diffusion models (LDMs) and generative adversarial networks (GANs), and the exact operations performed to generate AI content may depend on the type of inference module used.

In any case, the inference module 210 executes operations to generate the AI content. As described above, the AI content may take a variety of forms. For example, the inference module 210 may generate text, images, audio, and/or videos. As a specific example, the inference module 210 may generate a visual animation of a holographic projection responding to a user query. As another example, the inference module 210 may generate an audible response to the user query. In any example, the AI content may be transmitted to the vehicle AI agent 102 via the wireless communication channel 208, which then stores the AI content in the cache and displays or otherwise presents the AI content to the occupants of the vehicle 100 through an output system.

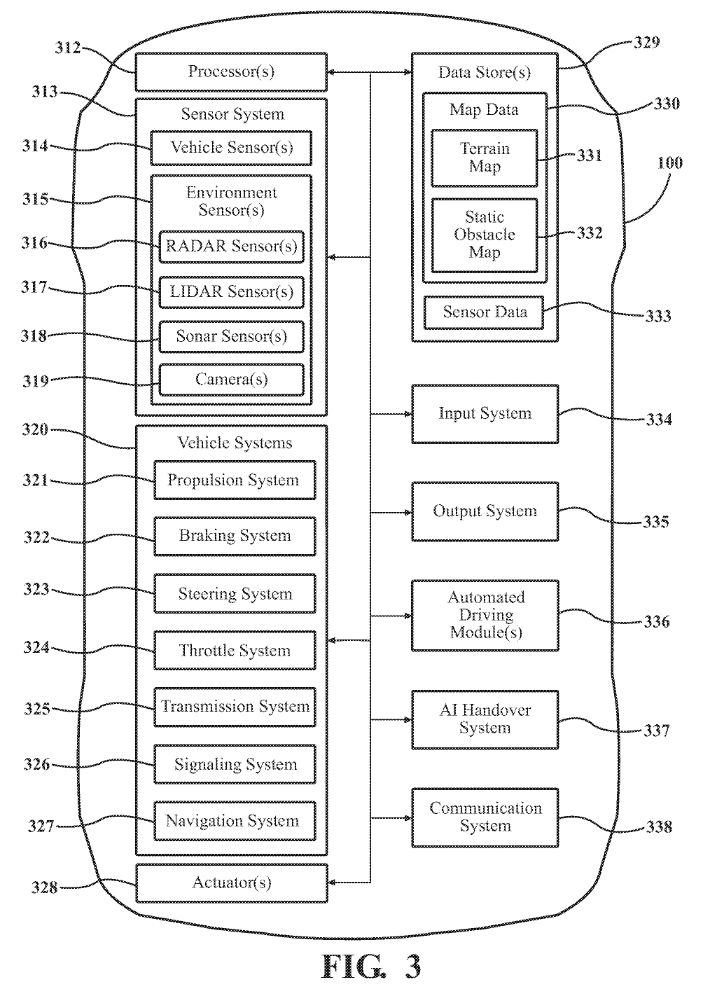

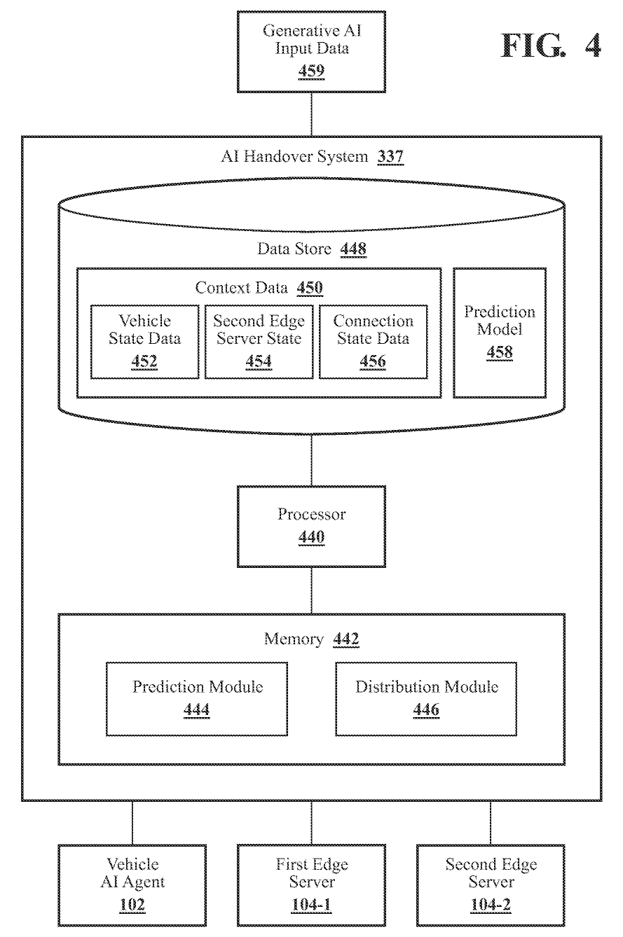

FIG. 3 illustrates one embodiment of a vehicle 100 within which systems and methods disclosed herein may be implemented. The vehicle 100 also includes various elements. It will be understood that in various embodiments, it may not be necessary for the vehicle 100 to have all of the elements shown in FIG. 3. The vehicle 100 can have different combinations of the various elements shown in FIG. 3. Further, the vehicle 100 can have additional elements to those shown in FIG. 3. In some arrangements, the vehicle 100 may be implemented without one or more of the elements shown in FIG. 3. While the various elements are shown as being located within the vehicle 100 in FIG. 3, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

Some of the possible elements of the vehicle 100 are shown in FIG. 3 and will be described along with subsequent figures. However, a description of many of the elements in FIG. 3 will be provided after the discussion of FIGS. 3-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes an AI handover system 337 that is implemented to perform methods and other functions, as disclosed herein, relating to improving the handover of AI content generation between edge servers 104-1 and 104-2.

As will be discussed in greater detail subsequently, the AI handover system 337, in various embodiments, is implemented partially within the vehicle 100, and as an edge-based service. For example, in one approach, functionality associated with at least one module of the AI handover system 337 is implemented within the vehicle 100, while further functionality is implemented within an edge-based computing system.

Moreover, the AI handover system 337, as provided for within the vehicle 100, functions in cooperation with a communication system 338. In one embodiment, the communication system 338 communicates according to one or more communication standards. For example, the communication system 338 can include multiple different antennas/transceivers and/or other hardware elements for communicating at different frequencies and according to respective protocols. The communication system 338, in one arrangement, communicates via a communication protocol, such as a WiFi, DSRC, vehicle-to-infrastructure (V2I), vehicle-to-vehicle (V2V), or another suitable protocol for communicating between the vehicle 100 and other entities in the cloud environment. Moreover, the communication system 338, in one arrangement, further communicates according to a protocol, such as GSM, EDGE, LTE, 5G, or another communication technology that provides for the vehicle 100 communicating with various remote devices (e.g., an edge-based server). In any case, the AI handover system 337 can leverage various wireless communication technologies to provide communications to other entities, such as members of the edge-computing environment.

With reference to FIG. 4, one embodiment of the AI handover system 337 of FIG. 3 is further illustrated. As depicted in FIG. 3, in one example, the AI handover system 337 is disposed on the vehicle 100. In another example, the AI handover system 337 may be disposed at a remote location, such as on the first edge server 104-1, the second edge server 104-2, or another remote computing device.

In any case, the AI handover system 337 may include a processor 440. In the example where the AI handover system 337 is disposed on the vehicle 100, as depicted in FIG. 3, the processor 440 may be the processor 312 of the vehicle 100, a separate processor from the processor 312 of the vehicle 100, or the AI handover system 337 may access the processor 312 through a data bus or another communication path that is separate from the vehicle 100.

In one embodiment, the AI handover system 337 includes a memory 442 that stores a prediction module 444 and a distribution module 446. The memory 442 is a random-access memory (RAM), read-only memory (ROM), a hard-disk drive, a flash memory, or another suitable memory for storing the modules 444 and 446. The modules 444 and 446 are, for example, machine-readable instructions that, when executed by the processor 312, cause the processor 312 to perform the various functions disclosed herein. In alternative arrangements, the modules 444 and 446 are independent elements from the memory 442 that are, for example, comprised of hardware elements. Thus, the modules 444 and 446 are alternatively ASICs, hardware-based controllers, a composition of logic gates, or another hardware-based solution.

Moreover, in one embodiment, the AI handover system 337 includes the data store 448. In the example where the AI handover system 337 is disposed on the vehicle 100, as depicted in FIG. 3, the data store 448 may be the data store 329 of the vehicle 100, a separate data store from the data store 329 of the vehicle 100, or the AI handover system 337 may access the data store 329 through a data bus or another communication path that is separate from the vehicle 100. In any case, the data store 329 is, in one embodiment, an electronic data structure stored in the memory 442 or another data storage device and that is configured with routines that can be executed by the processor 440 for analyzing stored data, providing stored data, organizing stored data, and so on. Thus, in one embodiment, the data store 448 stores data used by the modules 444 and 446 in executing various functions.

Specifically, the data store 448 stores context data 450. In general, context data 450 is the data by which the prediction module 444 predicts a handover time, which handover time is defined as the amount of time for the generative AI input data 459, any partially-completed AI content, and in some cases, session logs/session history to be transmitted to a second edge server 104-2, either from the vehicle AI agent 102 and/or from the first edge server 104-1. That is, the transfer of data between two entities (i.e., the vehicle 100 or first edge server 104-1 and second edge server 104-2) is not instantaneous, and the length of the handover period may determine which entity is to ultimately perform the AI content generation and transmit the resulting AI content to the vehicle AI agent 102. As such, the present AI handover system 337 determines a handover time for the aforementioned data, identifies an AI generation entity (i.e., the vehicle AI agent 102, the first edge server 104-1, or the second edge server 104-2), and transmits the generative AI input data 459, any partially-completed AI content, and in some cases the session logs/session history to the identified AI generation entity.

The predicted handover time may be partly defined by various pieces of context data 450. Specifically, the prediction module 444 may predict the handover time based on vehicle state data 452, second edge server state data 454, and vehicle-server connection state data 456. Each will be addressed in turn.

The vehicle state data 452 may include data indicative of the location of the vehicle 100, the speed of the vehicle 100, the direction of travel of the vehicle 100, a predicted trajectory of the vehicle 100, historical travel patterns for the vehicle 100, and a latency criteria of the vehicle AI agent 102. For example, the current location of the vehicle 100 and the direction of travel of the vehicle 100 may aid in identifying an edge server that is near the vehicle 100 and along the travel path of the vehicle 100.

Moreover, a trajectory prediction module may determine a predicted future trajectory of the vehicle 100. The predicted trajectory may be based on the location of the vehicle 100, the speed of the vehicle 100, and the direction of travel of the vehicle 100. In some cases, the predicted trajectory for the vehicle 100 may be based on machine-learning analysis where historical travel patterns for the vehicle 100 and historical travel patterns of other vehicles are used to determine a predicted trajectory of the vehicle 100. As with the location and direction of the vehicle, the predicted trajectory of the vehicle 100 may be used to identify edge servers along the predicted route of the vehicle 100. As such, the vehicle 100 may include sensors that collect such information. Example sensors include speed sensors, global positioning system (GPS) sensors, and the like. This information is collected by the vehicle sensors and shared with the AI handover system 337.

The vehicle state data 452 may also include the speed of the vehicle 100. The speed of the vehicle 100 may, along with the location and direction of travel of the vehicle 100, may define the amount of time before the vehicle 100 reaches the second edge server coverage area 106-2.

As another example, the vehicle state data 452 may include historical travel patterns for the vehicle 100, which historical travel patterns may be stored as logs in the vehicle 100 data store. As described above, historical travel patterns may inform a predicted trajectory. For example, a driver may regularly transit between two destinations (e.g., home and work). Accordingly, this historic behavior can be used to identify the edge servers located along the path between the driver’s home and work destinations. In other words, historic travel patterns may identify candidate edge servers to which the partially generated AI content and/or session history may be transmitted to provide continuous in-cabin AI content

As yet another example, the vehicle state data 452 may include a latency criteria of the vehicle AI agent 102. In general, the latency criteria for the vehicle AI agent 102 may be a target, or threshold, latency value for the presentation of AI content. For example, it may be desirable for the AI content to be presented within a few seconds of receiving a request. Accordingly, in this example, the few seconds may represent the latency criteria for the vehicle AI agent 102. Note that the latency criteria may vary based on the type of AI content and the application that distributes the AI content. For example, a navigational application that provides audible AI navigation instructions may have lower latency criteria, on account of desiring to provide timely navigational instructions, than a conversational holographic presentation that is responding to non-critical requests of information, such as educational and/or entertainment requests. In either case, this latency criteria may define the metric against which a predicted handover time is compared to determine which entity the AI content generation is assigned.

The context data 450 may also include second edge server data 454. In general, the second edge server state data 454 may define the state of the second edge server 104-2, which second edge server 104-2 is an edge server with a coverage area into which the vehicle 100 is going to travel along its path. For example, at the point in time captured in FIG. 1, the vehicle 100 may be within the first edge server coverage area 106-1. However, as the vehicle 100 travels, it may exit the first edge server coverage area 106-1 and enter the second edge server coverage area 106-2. The state of the second edge server 104-2 may dictate whether and how the generative AI input data is transmitted to the second edge server 104-2. The second edge server state data 454 therefore includes the data by which the state of the second edge server 104-2 may be determined. In an example, the second edge server state data 454 indicates at least one of an amount of available processing resources or a topology for a network to which the second edge server 104-2 pertains

More specifically, different edge servers may have different memory and processing resources. Moreover, the processing resources of one edge server may change over time based on the number of requests being filled. This information may affect the speed at which data can be transmitted to the second edge server 104-2. Accordingly, the second edge server 104-2 may include a sensor or processor that logs the real-time available processing resources and transmits such to the AI handover system 337.

In general, the topology of the network of edge servers indicates various information about the edge servers in that network. Specifically, the topology may indicate the location of various edge servers and their respective coverage areas. Accordingly, the network topology data may aid in identifying edge servers along the path of the vehicle 100 and in identifying potential discontinuities between the coverage areas of adjacent edge servers.

The context data 450 may further include vehicle-server connection state data 456. In general, the vehicle-server connection state data 456 may define the state of the wireless communication channel 208 between the vehicle 100 and the second edge server 104-2, which wireless communication channel 208 may adhere to a variety of different protocols such as GSM, EDGE, LTE, 5G, or another communication technology that provides for the vehicle AI agent 102 communicating with the second edge server 104-2. The capabilities, or state, of this wireless communication channel 208 may affect whether, and how, the generative AI input data 459 is transmitted to the second edge server 104-2. The vehicle-server connection state data 456 may indicate at least one of an available communication bandwidth of a vehicle-server connection (e.g., the wireless communication channel 208), a received signal strength across the vehicle-server connection (e.g., the wireless communication channel 208), or a data transmission rate across vehicle-server connection (e.g., the wireless communication channel 208). Accordingly, the AI handover system 337 may be in communication with a wireless communication channel monitor that records or logs this information and transmits such to the AI handover system 337. In one embodiment, the data store 448 stores the context data 450 along with, for example, metadata that characterize various aspects of the context data 450. For example, the metadata can include location coordinates (e.g., longitude and latitude), relative map coordinates or tile identifiers, time/date stamps from when the separate context data 450 was extracted, and so on.

In one embodiment, the data store 448 further includes a prediction model 458. In general, the prediction model 458 is relied on by the prediction module 444 to predict a handover time of the generative AI input data 459. That is, for given vehicle states, second edge server states, and vehicle-server connection states, there may be an expected handover time for the generative AI input data 459. The prediction model 458 may include the data and functions used to determine those expected handover times.

In an example, the prediction model 458 may include a series of lookup tables that map the vehicle, second edge server, and connection states to predicted handover times. For example, a lookup table may map vehicle projected trajectories, edge server available processing resources, and connection bandwidth to predicted handover times. While particular reference is made to a particular mapping (e.g., between a particular vehicle, second edge server, and connection states, and a particular handover time), the prediction model 458 may include other lookup tables that map other states to other predicted handover times.

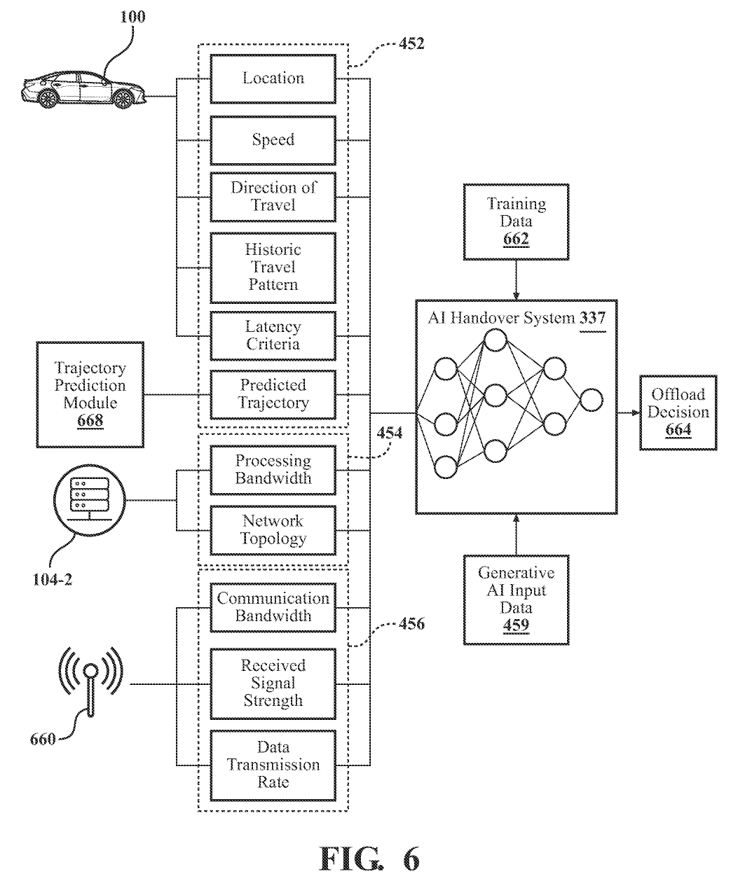

In an example, the prediction module 444 may be a machine-learning system that generates the predicted handover time based on identified patterns in a corpus of context data 450. In the context of the present application, a machine-learning-based prediction module 444 may rely on some form of machine learning, whether supervised, unsupervised, reinforcement, or any other type, to predict handover times based on context data 450 and the prediction model 458. The distribution module 446 uses those predicted handover times to distribute the generative AI input data 459 to an appropriate entity (e.g., the second edge server 104-2, the first edge server 104-1, or the vehicle AI agent 102). In some cases, the distribution module 446 may alter the generative AI input data 459 that is transmitted and/or alter the parameters by which the AI content is created. In any case, the prediction model 458 may include weights (including both trainable and non-trainable), biases, variables, activation functions, rules, algorithms, parameters, and other elements that operate to output a predicted handover time based on the context data. Additional details regarding the operation of a machine-learning prediction module 444 are provided below in connection with FIG. 6.

The AI handover system 337 further includes various modules that cause the processor 440 to perform the functionality described herein. The AI handover system 337 may include a prediction module 444 that includes instructions that, when executed by the processor 440, cause the processor 440 to receive a request to hand over AI content generation to a second edge server 104-2. As described above, vehicles are not stationary and may move between edge server coverage areas. Accordingly, as the vehicle 100 approaches the edge of a current edge server coverage area (i.e., the first edge server coverage area 106-1), information may be transmitted to the AI handover system 337, indicating that a potential handover may be imminent. In an example, the request may be based on a comparison of the location of the vehicle 100, the speed of the vehicle 100, the direction of travel of the vehicle 100, and/or the predicted trajectory of the vehicle 100 with the coverage area of an edge server that is currently providing AI generation services. That is, this vehicle state data 452 may be relied on to determine when and if a handover should occur to continue to present AI content through the vehicle AI agent 102. As such, the AI handover system 337 may continually communicate with the vehicle 100 to receive the vehicle state data 452. The AI handover system 337 may also store data regarding edge server coverage areas, such that the AI handover system 337 may determine when the vehicle 100 is approaching a coverage area boundary.

The prediction module 444 also includes instructions that, when executed by the processor 440, cause the processor 440 to extract context data 450 for a handover. As described above, the context data 450 may indicate a vehicle state, a second edge server state, and a vehicle-server connection state. Accordingly, the prediction module 444 is in communication with the vehicle 100, the edge servers 104-1 and 104-2, and a wireless communication channel 208 monitor to determine the various state information from which a handover time is predicted.

The prediction module 444 also includes instructions that, when executed by the processor 440, cause the processor 440 to predict a handover time of the generative AI input data 459 based on the context data 450. That is, as described above, certain states may infer a specific handover time. Based on the predicted handover time, the AI handover system 337 may hand over the AI content generation to one of the different entities.

Specifically, the prediction module 444, considering the vehicle state data 452, the second edge server data 454, and the vehicle-server connection data 456, may predict how much time it would take to transfer the generative AI input data 459 (which may include input prompts, session history, and partially-created AI content) to the second edge server 104-2. The predicted time may vary depending on various circumstances, including the vehicle state, the second edge server state, the connection state, and the generative AI input data.

The prediction module 444 may predict the handover time in various ways. In one example, the prediction module 444 may consult a lookup table or a series of lookup tables that map different vehicle states, second edge server states, and/or vehicle-server connection states to predicted handover times.

In another example, the prediction module 444 may be a machine learning module that predicts handover times based on patterns identified in a training dataset. That is, the machine-learning prediction module 444 may be an unsupervised, supervised, or reinforced learning module. In this example, the inputs to the machine-learning module may be vehicle state data 452, second edge server state data 454, and vehicle-server connection state data 456 as extracted from the vehicle 100, the second edge server 104-2, and a wireless communication channel 208 monitor. Nodes within the machine-learning module process the context data 450 to output predicted handover times.

As such, the prediction module 444, in some examples relying on machine learning, receives the context data 450 as input and generates a target destination for the generative AI input data 459. For example, when the context data 450 indicates that the predicted handover time exceeds a predetermined value (i.e., the handover will take longer than the target duration), the distribution module 446 may distribute the generative AI input data 459 to the vehicle AI agent 102. By comparison, when the context data 450 indicates that the predicted handover time is less than a predetermined value (i.e., the handover will be shorter than a target duration), the distribution module 446 may distribute the generative AI input data 459 to the second edge server 104-2 or the first edge server 104-1 depending on whether or not there is a coverage discontinuity. Additional details regarding how vehicle state, second edge server state, and vehicle-server connection state may affect predicted handover time are provided below in connection with FIG. 6.

In one configuration, the machine learning algorithm is embedded within the prediction module 444, such as a neural network, to perform handover time prediction based on the context data 450. Of course, in further aspects, the prediction module 444 may employ different machine learning algorithms or implement different approaches for performing the prediction. Whichever particular approach the prediction module 444 implements, the prediction module 444 provides an output of predicted handover time.

As described herein, a machine learning algorithm includes but is not limited to deep neural networks (DNN), including transformer networks, convolutional neural networks, recurrent neural networks (RNN), Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the AI handover system 337 or another system generally trains the machine learning algorithm according to a particular training approach, which may include supervised training, self-supervised training, reinforcement learning, and so on. In contrast to training/learning of the machine learning algorithm, the AI handover system 337 implements the machine learning algorithm to perform estimation and/or prediction.

It should be appreciated that the prediction module 444, in combination with the prediction model 458, can form a computational model, such as a neural network model. In any case, the prediction module 444, when implemented with a neural network model or another model in one embodiment, implements functional aspects of the prediction model 458 while further aspects, such as learned weights, may be stored within the data store 448. Accordingly, the prediction model 458 is generally integrated with the prediction module 444 as a cohesive, functional structure. Additional details regarding the machine-learning operation of prediction module 444 and prediction model 458 are provided below in connection with FIG. 6.

The distribution module 446 includes instructions that, when executed by the processor 440, cause the processor 440 to distribute the generative AI input data 459 based on the predicted handover time. Specifically, based on the state of the vehicle 100, the second edge server 104-2, and the vehicle-server connection, different entities (i.e., the vehicle 100, the second edge server 104-2, or the first edge server 104-1) may be better equipped to handle the generation of the AI content. For example, if there are sufficient second edge server 104-2 processing resources, the generative AI input data 459 may be distributed to the second edge server 104-2, which may have more time for content generation than the first edge server 104-1 on account of the vehicle 100 just entering the second edge server coverage area 106-2 and exiting the first edge server coverage area 106-1.

As another example, if there is an upcoming coverage discontinuity, it may be desirable for the first edge server 104-1 to complete the AI content generation before the vehicle 100 leaves the first edge server coverage area 106-1. As yet another example, if the handover time is deemed to be too long, i.e., less than some satisfactory threshold as determined by various criteria, the generative AI input data 459 may be transmitted to the vehicle AI agent 102, which may allow for AI content generation, albeit at a lower quality.

Accordingly, the distribution module 446 determines the destination of the generative AI input data 459 based on the output of the prediction module 444. In distributing this generative AI input data 459, the distribution module 446 may share a wired or wireless connection with each of the vehicle AI agent 102, the first edge server 104-1, and the second edge server 104-2. That is, the distribution module 446 not only identifies the intended target for the generative AI input data 459 but also distributes the generative AI input data to that target. As described below in connection with FIG. 6, the identification of an intended target and transmission of the generative AI input data 459 to such may be based on various criteria related to the vehicle state, the second edge server state, and the vehicle-server connection state.

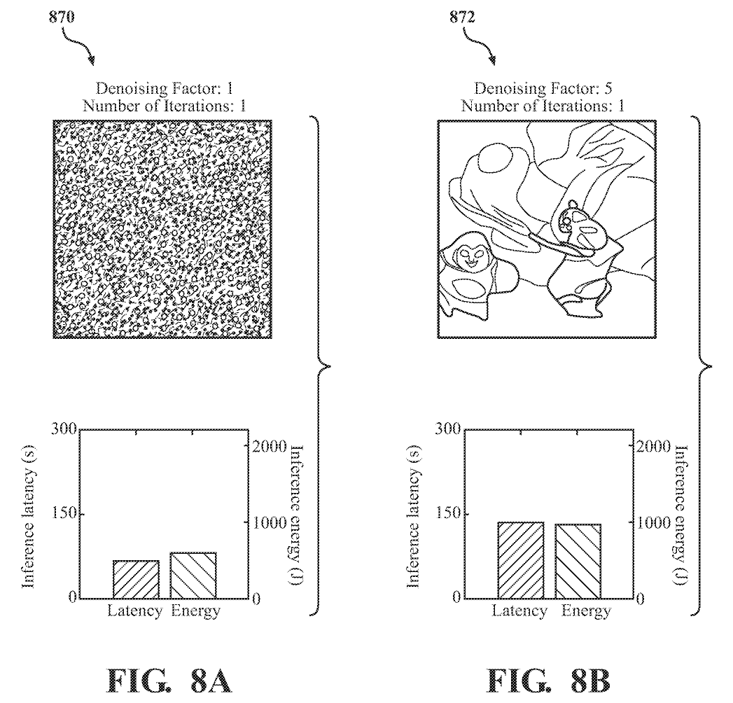

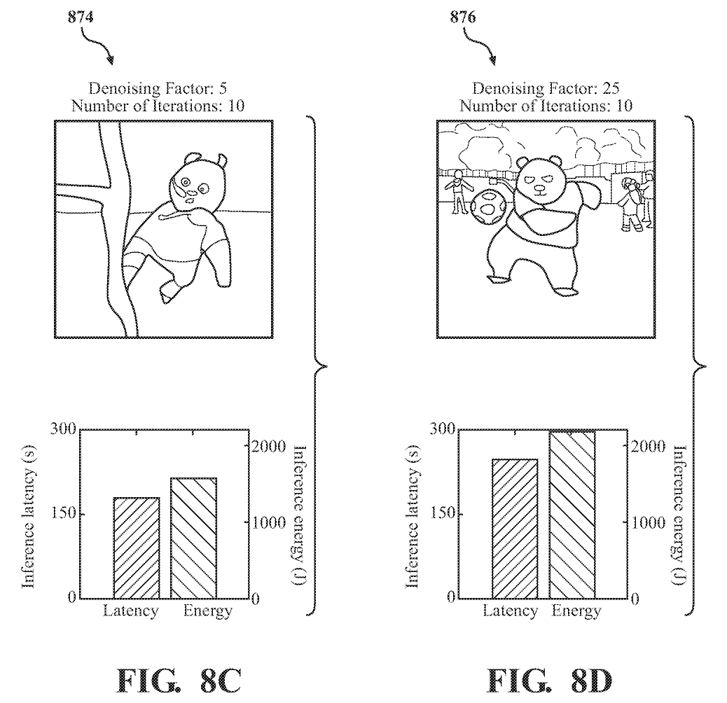

In addition to transmitting the generative AI input data 459 to an intended recipient, the distribution module 446 may also determine the parameters of AI content generation and portions of a generative AI input data 459 package. For example, it may be the case that rather than transmitting the generative AI input data 459 to a new edge server (i.e., the second edge server 104-2), the distribution module 446 may continue to transmit the generative AI input data 459 to an edge server currently serving the vehicle 100 (i.e., the first edge server 104-1) in whose coverage area the vehicle 100 currently resides. In this example, to ensure that the AI content is generated before the vehicle 100 exits the first edge server coverage area 106-1, the distribution module 446 may alter the AI generation parameters. Additional details regarding the alteration of AI content parameters are presented below in connection with FIGS. 8A – 8D.

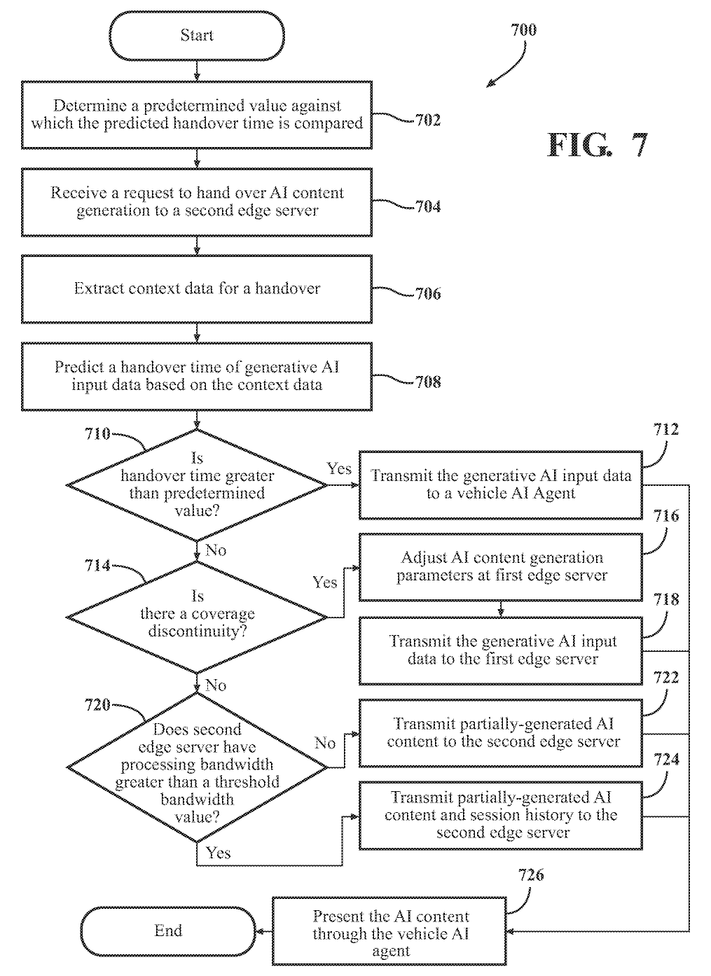

As another example, it may be that the second edge server 104-2, has different amounts of processing resources available to handle AI content generation. Based on the available resources, the distribution module 446 may distribute different data packets as part of the generative AI input data 459. For example, as depicted in FIG. 7, if there is a threshold amount of available processing resources, the distribution module 446 may distribute the session history and any partially generated AI content. The session history may provide additional data, such as historical usage patterns, which can be used to present customized, user-specific AI content. By comparison, if there is less than a threshold amount of available processing resources, the distribution module 446 may block the distribution of session history. This may still facilitate the generation of AI content, albeit with less reliance on user historical interaction with the vehicle AI agent 102.

Regardless of the location of AI content generation, the AI handover system 337 may present the AI content to the vehicle AI agent 102. In the case where the generative AI input data 459 is distributed to the vehicle AI agent 102, this may include locally generating the AI content. In the case where the generative AI input data 459 is distributed to the first edge server 104-1, this may include issuing a command for the first edge server 104-1 to transmit the AI content to the vehicle AI agent 102. In the case where the generative AI input data 459 is distributed to the second edge server 104-2, this may include issuing a command for the second edge server 104-2 to transmit the AI content to the vehicle AI agent 102.

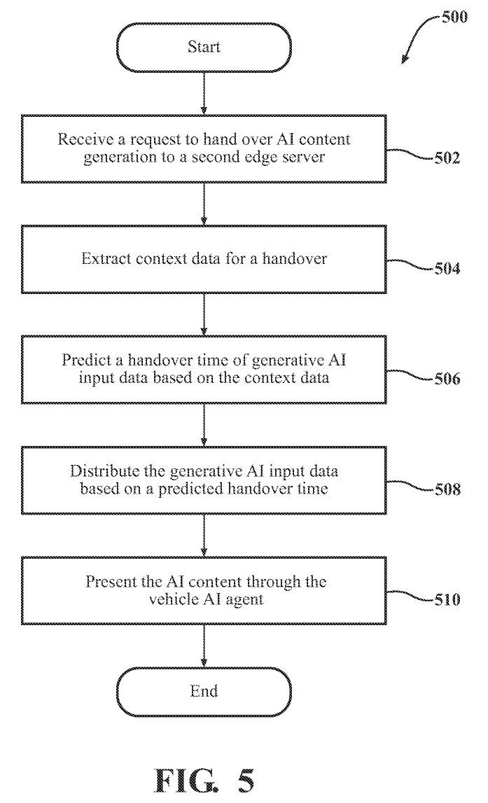

Additional aspects of providing AI content for consumption in the cabin of vehicle 100 will be discussed in relation to FIG. 5. FIG. 5 illustrates a flowchart of a method 500 that is associated with generating AI content based on a predicted handover time. Method 500 will be discussed from the perspective of the AI handover system 337 of FIGS. 3 and 4. While method 500 is discussed in combination with the AI handover system 337, it should be appreciated that the method 500 is not limited to being implemented within the AI handover system 337 but is instead one example of a system that may implement the method 500.

At 502, the AI handover system 337 receives a request to hand over AI content generation to a second edge server 104-2. As described above, the request may be based on the proximity of the vehicle 100 to a boundary of an edge server coverage area in which the vehicle 100 is presently found. That is, the edge server where the vehicle 100 is currently located (i.e., the first edge server 104-1) may be in continuous communication with the AI handover system 337, which may be installed on the vehicle 100 or at a remote location. As such, the AI handover system 337 may have access to topology information indicating the service or coverage area of the first edge server 104-1. The AI handover system 337 may also be in continual communication with the vehicle 100, which may transmit certain information, such as vehicle location, speed, and direction of travel. Accordingly, based on this information, the AI handover system 337 may determine when the vehicle 100 is within a threshold distance from a boundary of the first edge server coverage area 106-1 and may request a handover of the AI content generation. As indicated, the request to hand over AI content generation may comprise a request to transmit generative AI input data 459, which is used to generate AI content for presentation at the vehicle 100. In an example, the generative AI input data 459 includes an input prompt from the occupant of the vehicle 100, any partially generated AI content, and a session history, which may be relied on when generating the AI content.

At 504, the prediction module 444 may extract context data 450 for a handover. As described above, the amount of time it may take to hand over the generative AI input data 459 may be defined by various pieces of information collectively referred to as a vehicle state, a second edge server state, and a vehicle-server connection state. This data may be periodically or continuously transmitted to the AI handover system 337 from the vehicle 100, the second edge server 104-2, and a wireless communication channel 208 monitor. In either case, at 506, the prediction module 444 may predict a handover time of generative AI input data 459 based on the context data 450. That is, via lookup tables or a machine-learning operation, the prediction module 444 may infer how long it will take to transmit the generative AI input data 459 based on the vehicle state, the second edge server state, and the vehicle-server connection state. The prediction may also be based on the generative AI input data 459 itself. For example, more complex AI content, such as three-dimensional holographic projections, may consume more transmission and processing resources to process and render. Accordingly, the handover time for complex AI content may be greater than for less complex AI content, such as text-to-image AI or conversational AI.

In either case, at 508, the distribution module 446 distributes the generative AI input data 459 based on a predicted handover time. That is to say, the predicted handover time may determine which entity receives the generative AI input data and generates the AI content. Moreover, in some cases, the predicted handover time may dictate the data transmitted as the generative AI input data 459. Still further, the predicted handover time may dictate the AI content parameters.

Once distributed, at 510, the AI content may be presented through the vehicle AI agent 102. This may include generating the AI content through the vehicle AI agent 102 or transmitting AI content generated at either the first edge server 104-1 or the second edge server 104-2 to the vehicle AI agent 102, where it may be cached and presented through the in-cabin system.

All this is done to efficiently provide the occupant of the vehicle 100 with AI content. Specifically, the present AI handover system 337 provides an informed assignment of AI generative duties to the entity most capable of handling such, given the specific contextual setting. Thus, rather than a one-size-fits-all approach where generative AI input data 459 is handed over upon exiting a current edge server coverage area, the present AI handover system 337 considers the contextual setting to determine which entity can provide the highest quality AI content, which entity may differ based on the contextual setting. Moreover, as described above, it may be that the vehicle 100, upon exiting the first server coverage area 106-1, does not enter another edge server’s coverage area. Without the present system, the vehicle 100 may lose the ability to present AI content. Accordingly, the present AI handover system 337 ensures AI content delivery in circumstances (e.g., service discontinuity) that may otherwise result in a loss of AI capability. Thus, in summary, the present AI handover system 337 increases the quality and reliability of generative AI content delivery, all while conserving resources by assigning AI generation to those entities best suited to deliver the AI content based on context-specific information.

FIG. 6 illustrates one embodiment of a machine-learning AI handover system 337 that is associated with distributing generative AI input data 459 based on a predicted handover time. As described above, in general, the prediction module 444 determines a predicted handover time, and the distribution module 446 determines to which of a vehicle AI agent 102, a first edge server 104-1, and a second edge server 104-2 the generative AI input data 459 should be distributed, i.e., the offload decision 664.

Specifically, the AI handover system 337 may share a wireless connection with the vehicle 100 from which vehicle state data 452, such as the location of the vehicle 100, the speed of the vehicle 100, the direction of travel of the vehicle 100, and the historical travel patterns of the vehicle 100 may be extracted. From this information, the AI handover system 337 may track the location of the vehicle 100 over time and determine 1) a predicted time and location where the vehicle 100 may leave the first edge server coverage area 106-1) and 2) an edge server into whose coverage area the vehicle 100 is heading. From this information, the AI handover system 337 may also determine an estimated time when the vehicle 100 is to enter and exit respective coverage areas and, thus, a time when a handover should be completed to ensure continuous delivery of AI content.

In an example, the vehicle 100 may also share latency criteria for the vehicle AI agent 102. This latency criteria may be the benchmark against which a predicted handover time is compared to determine the entity that will complete the AI content generation. In general, the latency criteria may define a target latency or duration from when a content request is transmitted to when the content is delivered. In the context of the present specification, the latency may be the duration from when a request for AI content is generated to when the AI content is delivered. The latency criteria may vary based on the application. For example, for a text-to-image conversion, the latency may be on the order of milliseconds. By comparison, the latency may be on the order of seconds for more computationally expensive operations, such as those involving conversational AI.

The AI handover system 337 may also share a wireless connection with a trajectory prediction module 668. In general, the trajectory prediction module 668 includes a processor and memory that predicts the trajectory of the vehicle 100 based on various pieces of information, such as the location of the vehicle 100, the speed of the vehicle 100, the direction of travel of the vehicle 100, and the historic travel patterns. As with these individual pieces of information, the predicted trajectory of the vehicle 100 may aid in identifying an edge server along the path of the vehicle 100 and the point in time when the vehicle 100 is likely to enter the coverage area of the edge server.

The AI handover system 337 may also share a wireless connection with the second edge server 104-2, from which the second edge server state data 454 may be extracted. In general, the second edge server state data 454 may indicate the ability of the second edge server to fulfill the request for AI content. For example, an edge server with fewer available processing resources may exhibit increased latency when producing the AI content. As described above, if insufficient, it may be desirable to transmit the generative AI input data 459 to the first edge server 104-1, which may have more capability to handle the request. Accordingly, via the AI handover system 337 to the second edge server 104-2 wireless connection, the AI handover system 337 may acquire an amount of available processing resources of the second edge server 104-2. Via this connection, the AI handover system 337 may also acquire the topology for the network to which the second edge server 104-2 pertains. This topology may indicate the relative location of different edge servers 104. Along with the vehicle state data 452, from this information, the AI handover system 337 may identify edge servers along the travel path of the vehicle 100 and when the vehicle 100 is likely to enter the respective coverage area.

The AI handover system 337 may also share a wireless connection with a wireless communication channel monitor 660. In general, the wireless communication channel monitor 660 monitors the state of the wireless communication channel 208. In general, the vehicle-server connection state data 456 may indicate the ability of the wireless communication channel 208 to handle the data transmission of the generative AI input data 459 and the resulting AI content. For example, a wireless communication channel 208 with limited available network bandwidth may exhibit increased latency when transmitting AI content and, in some cases, may not have sufficient bandwidth to transmit the AI data, which can be quite large in certain examples. Accordingly, via the AI handover system 337 to the second edge server 104-2 wireless connection, the AI handover system 337 may acquire an available communication bandwidth of a vehicle-server connection (i.e., the wireless communication channel 208) and a received signal strength across the vehicle-server connection (i.e., the wireless communication channel 208). That is, the wireless communication channel monitor 660 may measure the power of transmitted signals across the wireless communication channel 208 and transmit such to the AI handover system 337 as a measure of the ability of the wireless communication channel 208 to handle the AI data transmission. Via the wireless communication channel monitor 660, the AI handover system 337 may receive a data transmission rate across the vehicle-server connection (i.e., the wireless communication channel 208), which may be another or additional measure of the vehicle-server connection ability to handle the AI data transmission.

As depicted in FIG. 6, the AI handover system 337 may be a machine-learning system. That is, the AI handover system 337, and more specifically, the prediction module 444, may include instructions that cause the processor 440 to predict the handover time based on machine-learning processing of the generative AI input data 459.

In general, a machine-learning system identifies patterns and deviations based on previously unseen data. In the context of the present application, a machine-learning AI handover system 337 relies on some form of machine learning, whether supervised, unsupervised, reinforcement, or any other type of machine learning, to identify patterns in context data 450 and generative AI input data 459, predict a handover time based on such, and select whether to transmit the generative AI input data to the vehicle AI agent 102, the first edge server 104-1, or the second edge server 104-2.

In one particular example, the machine-learning AI handover system 337 may be a neural network that includes any number of 1) input nodes that receive context data 450 and generative AI input data 459, 2) hidden nodes, which may be arranged in layers connected to input nodes and/or other hidden nodes and which include computational instructions for computing outputs, and 3) output nodes connected to the hidden nodes which generate an output, i.e., offload decision 664.

In any case, as depicted in FIG. 6, the inputs to the AI handover system 337 include the vehicle state data 452, the second edge server state data 454, and the vehicle-server connection state data 456, the generative AI input data 459, and training data 662. The AI handover system 337, based on trained patterns determined from the training data 662, predicts a handover time for the transfer of generative AI input data 459 and determines to which entity the generative AI input data 459 should be transmitted. Note that while FIG. 6 depicts a supervised machine-learning system, i.e., one that is trained based on training data 662, the AI handover system 337 may be an unsupervised machine-learning system as well.

FIG. 7 illustrates a flowchart for one embodiment of a method 700 that is associated with distributing generative AI input data 459 based on a predicted handover time.

At 702, the AI handover system 337 determines a predetermined value against which the predicted handover time is compared. That is, to determine the sufficiency of a predicted handover time to meet the criteria for a given scenario, the AI handover system 337 first determines a benchmark against which the predicted handover time is compared. In an example, the predetermined value may be based on various information described above, such as the latency criteria as specified by the vehicle AI agent 102, the time before which the vehicle 100 is to leave the first edge server coverage area 106-1 (which time may be determined based on the location, speed, direction of travel, and predicted trajectory of the vehicle 100), and any detected coverage discontinuities. This predetermined value may also be based on the generative AI input data 459. In any case, at 704, the AI handover system 337 may receive a request to hand over AI content generation to a second edge server 104-2, as described above, and at 706, the AI handover system 337 may extract context data 450 for a handover. Based on the context data 450, at 708, the prediction module 444 may predict a handover time of the generative AI input data 459 based on the context data 450. As described above, based on the predicted handover time, the AI handover system 337 may perform various operations to assign and transmit the generative AI input data to an appropriate entity. FIG. 7 depicts various specific operations that may be performed.

Specifically, at 710, the AI handover system 337 may determine whether the predicted handover time exceeds a predetermined value. If so (block 710, determination YES), at 712, the AI handover system 337 may transmit the generative AI input data 459 to a vehicle AI agent 102. That is, the distribution module 446 may include instructions that cause the processor 440 to generate the AI content at the vehicle 100, responsive to the predicted time being greater than a predetermined amount. That is, if the predicted handover time exceeds the predetermined amount, this may indicate that the second edge server 104-2 is unable to generate the AI content to meet the latency criteria of the vehicle AI agent 102. Accordingly, in this example, the AI content may be generated locally to ensure the delivery of the AI content, albeit with lower quality, due to the lower processing and memory resources of the vehicle AI agent 102 compared to the second edge server 104-2.

By comparison, if the predicted handover time is less than the predetermined value (block 710, determination YES), the distribution module 446 may transmit the generative AI input data 459 to the second edge server 104-2. However, in some examples, before transmitting the generative AI input data 459 to the second edge server 104-2, the AI handover system 337 may perform additional operations to ensure the proper distribution of the generative AI input data 459 and the generation of the AI content.

Specifically, at 714, responsive to the predicted handover time being less than the predetermined value, the AI handover system 337 may determine if there is a coverage discontinuity between the first edge server coverage area 106-1 and the second edge server coverage area 106-2. Such a discontinuity may indicate an interruption in the AI presentation within the vehicle 100. If there is a coverage discontinuity detected (block 714, determination YES), the AI handover system 337 may take certain remedial measures to ensure that there is no interruption of the AI interface of the vehicle AI agent 102. Specifically, at 716, the AI handover system 337, and more specifically, the distribution module 446, may adjust AI content generation parameters of a first edge server 104-1 to complete the AI content generation while the vehicle 100 is in the first edge server coverage area 106-1.

That is, when generating AI content, the AI-generating module may do so with certain AI content generation parameters. For example, a diffusion model AI module may operate by starting with an image of random noise. With each iteration, the module may take the generated image, remove some noise, compare it to the input prompt, and change the noisy canvas until it reaches a coherent image that matches the input prompt. In this example, the AI content generation parameters may include: 1) a denoising factor, which represents the degree of image denoising at each iteration, and 2) the number of iterations, which refers to the number of sampling passes used during the AI content generation process. Examples of these two AI content generation parameters and the effect of altering them on the AI content are provided below in connection with FIGS. 8A-8D.

Note that while specific reference is made to the alteration of specific AI content generation parameters, the distribution module 446 may alter a variety of AI content generation parameters to reduce the amount of time it takes to generate the AI content, such that the AI content may be presented while the vehicle 100 is in the first server coverage area 106-1 and before the vehicle 100 departs this coverage area 106-1 where AI service may be lost due to the coverage area discontinuity. In a more general sense, other machine-learning models, such as a generative adversarial network (GAN), operate by iteratively processing input data and updating machine-learning parameters. In these systems, the number of iterations is an AI content generation parameter that may be adjusted.

In any case, following the adjustment of the AI content generation parameters, the distribution module 446, at 718, may transmit the generative AI input data to the first edge server 104-1 for AI content generation.

Responsive to a determination that there is no coverage discontinuity (block 714, determination NO) (i.e., that there is coverage continuity), the distribution module 446 may transmit the generative AI input data 459 to the second edge server 104-2. However, in some examples, before transmitting the generative AI input data 459 to the second edge server 104-2, the AI handover system 337 may perform additional operations to ensure the proper distribution of the generative AI input data 459 and the generation of the AI content.

Specifically, at 720, the AI handover system 337 may determine whether the second edge server 104-2 has available processing resources greater than a predetermined processing value, which predetermined processing value may vary based on the generative AI input data 459 and the AI content to be generated. For example, a target predetermined processing value may be greater than 5 gigabytes (5 GB) or 10 GB, as processing amounts less than this may result in interrupted AI content presentation. While particular reference is made to a particular predetermined processing value that may trigger alteration of the generative AI input data 459 that is transmitted, the predetermined processing value may be any value as determined by the vehicle AI agent 102, the AI handover system 337, or an administrator.

If the second edge server 104-2 has less than the predetermined processing value of available processing resources (block 720, determination NO), the distribution module 446 may send a reduced amount of the generative AI input data 459 to the second edge server 104-2. For example, the distribution module 446 may transmit the partially generated AI content (generated by the first edge server 104-1) to the second edge server 104-2 while blocking the transmission of the session history to the second edge server 104-2. That is, as described above, it may be the case that AI content generation responsive to a request is not completed while the vehicle 100 is in the first edge server coverage area 106-1. In this example, the partially created AI content is transmitted to the second edge server 104-2, which may then complete the AI content generation and transmit it to the vehicle AI agent 102. Moreover, it may be the case that AI content generation is based not only on the currently received input prompt but also on past interactions between the user and the AI interface. That is, the session history may inform the AI content. In this example, to conserve processing resources, the distribution module 446 may preclude the transmission of such so that the AI content may still be generated and presented, albeit with a reduced context influence.

If there are sufficient processing resources available (block 720, determination YES), at 724, the distribution module 446 may transmit both the session history and the partially generated AI content to the second edge server 104-2. By comparison, if insufficient processing resources are available (block 720, determination NO), at 722, the distribution module 446 may transmit the partially generated AI content while blocking the transmission of the session history. Again, as described, the sufficiency of the available processing resources can be determined by comparing the amount of available resources to the predetermined processing value.

In any of these cases, at 726, the system may present AI content through the vehicle AI agent 102, whether the presentation includes locally generating the AI content at the vehicle AI agent 102 or transmitting the generated AI content to the vehicle AI agent 102 for presentation. Thus, the present method 700 provides AI content through a vehicle AI agent 102, which AI content generation is customized to the specifics of the context of the environment (i.e., based on the vehicle state, the second edge server state, and the vehicle-server connection state).

FIGS. 8A – 8D depict the alteration of example AI content generation parameters. As described above, various AI generation modalities (e.g., GANs and diffusion models, among others) utilize different AI generation parameters to generate AI. These parameters may be altered to ensure that AI content is provided to an individual in a moving vehicle 100. FIGS. 8A – 8D illustrate the impact of changing various diffusion model parameters in terms of latency, energy, and image quality. A first image 870, depicted in FIG. 8A, which is processed with a denoising factor of 1 and an iteration count of 1, may be very noisy but may be generated with low latency and low inference energy. By comparison, a second image 872, depicted in FIG. 8B, with a denoising factor of 5 and an iteration count of 1, may be less noisy but may exhibit greater latency and consume more inference energy. Still further, a third image 874, depicted in FIG. 8C, with a denoising factor of 5 and an iteration count of 10, may exhibit even greater latency and consume more inference energy, but may result in a higher-quality image than either of the first image 870 and the second image 872. Still further, a fourth image 876, depicted in FIG. 8D, may be generated with a denoising factor of 25 and an iteration count of 10. This may provide a clear, high-quality picture, but it may exhibit greater latency and consume more inference energy. As such, FIGS. 8A – 8D depict the trade-off between image quality and latency/energy that may be altered to ensure AI content delivery before the vehicle 100 enters a region where there are no AI content generation capabilities (i.e., a coverage discontinuity)

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 312. In one or more arrangements, the processor(s) 312 can be a primary/centralized processor of the vehicle 100 or may be representative of many distributed processing units. For instance, the processor(s) 312 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support the operation of the vehicle 100.

The vehicle 100 can include one or more data stores 329 for storing one or more types of data. The data store 329 can be comprised of volatile and/or non-volatile memory. Examples of memory that may form the data store 329 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 329 is a component of the processor(s) 312. In general, the data store 329 is operatively connected to the processor(s) 312 for use thereby. The term "operatively connected," as used throughout this description, can include direct or indirect connections, including connections without direct physical contact.

In one or more arrangements, the one or more data stores 329 include various data elements to support functions of the vehicle 100, such as semi-autonomous and/or autonomous functions. Thus, the data store 329 may store map data 330 and/or sensor data 333. The map data 330 includes, in at least one approach, maps of one or more geographic areas. In some instances, the map data 330 can include information about roads (e.g., lane and/or road maps), traffic control devices, road markings, structures, features, and/or landmarks in the one or more geographic areas. The map data 330 may be characterized, in at least one approach, as a high-definition (HD) map that provides information for autonomous and/or semi-autonomous functions.

In one or more arrangements, the map data 330 can include one or more terrain maps 331. The terrain map(s) 331 can include information about the ground, terrain, roads, surfaces, and/or other features of one or more geographic areas. The terrain map(s) 331 can include elevation data in the one or more geographic areas. In one or more arrangements, the map data 330 includes one or more static obstacle maps 332. The static obstacle map(s) 332 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 333 is data provided from one or more sensors of the sensor system 313. Thus, the sensor data 333 may include observations of a surrounding environment of the vehicle 100 and/or information about the vehicle 100 itself. In some instances, one or more data stores 329 located onboard the vehicle 100 store at least a portion of the map data 330 and/or the sensor data 333. Alternatively, or in addition, at least a portion of the map data 330 and/or the sensor data 333 can be located in one or more data stores 329 that are located remotely from the vehicle 100.

As noted above, the vehicle 100 can include the sensor system 313. The sensor system 313 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 313 and/or the one or more sensors can be operatively connected to the processor(s) 312, the data store(s) 329, and/or another element of the vehicle 100.

Various examples of different types of sensors will be described herein. However, it will be understood that the embodiments are not limited to the particular sensors described. In various configurations, the sensor system 313 includes one or more vehicle sensors 314 and/or one or more environment sensors. The vehicle sensor(s) 314 function to sense information about the vehicle 100 itself. In one or more arrangements, the vehicle sensor(s) 314 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 313 can include one or more environment sensors 315 that sense the surrounding environment (e.g., external) of the vehicle 100 and/or, in at least one arrangement, the environment of the passenger cabin of the vehicle 100. For example, the one or more environment sensors 315 sense objects in the surrounding environment of the vehicle 100. Such obstacles may be stationary objects and/or dynamic objects. Various examples of sensors of the sensor system 313 will be described herein. The example sensors may be part of the one or more environment sensors 315 and/or the one or more vehicle sensors 314. However, it will be understood that the embodiments are not limited to the particular sensors described. As an example, in one or more arrangements, the sensor system 313 includes one or more radar sensors 316, one or more LIDAR sensors 317, one or more sonar sensors 318 (e.g., ultrasonic sensors), and/or one or more cameras 319 (e.g., monocular, stereoscopic, RGB, infrared, etc.).

Continuing with the discussion of elements from FIG. 1, the vehicle 100 can include an input system 334. The input system 334 generally encompasses one or more devices that enable the acquisition of information by a machine from an outside source, such as an operator. The input system 334 can receive an input from a vehicle passenger (e.g., a driver/operator and/or a passenger). Additionally, in at least one configuration, the vehicle 100 includes an output system 335. The output system 335 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 320. Various examples of the one or more vehicle systems 320 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 321, a braking system 322, a steering system 323, a throttle system 324, a transmission system 325, a signaling system 326, and a navigation system 327.

The navigation system 327 can include one or more devices, applications, and/or combinations thereof to determine the geographic location of the vehicle 100 and/or to determine a travel route for the vehicle 100. The navigation system 327 can include one or more mapping applications to determine a travel route for the vehicle 100 according to, for example, the map data 330. The navigation system 327 may include or at least provide connection to a global positioning system, a local positioning system, or a geolocation system.

In one or more configurations, the vehicle systems 320 function cooperatively with other components of the vehicle 100. For example, the processor(s) 312, the AI handover system 337, and/or automated driving module(s) 336 can be operatively connected to communicate with the various vehicle systems 320 and/or individual components thereof. For example, the processor(s) 312 and/or the automated driving module(s) 336 can be in communication to send and/or receive information from the various vehicle systems 320 to control the navigation and/or maneuvering of the vehicle 100. The processor(s) 312 and/or the automated driving module(s) 336 may control some or all of these vehicle systems 320.

For example, when operating in the autonomous mode, the processor(s) 312 and/or the automated driving module(s) 336 control the heading and speed of the vehicle 100. The processor(s) 312 and/or the automated driving module(s) 336 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 328 in at least one configuration. The actuators 328 are, for example, elements operable to move and/or control a mechanism, such as one or more of the vehicle systems 320 or components thereof responsive to electronic signals or other inputs from the processor(s) 312 and/or the automated driving module(s) 336. The one or more actuators 328 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory machine-readable instructions that, when executed by the processor 312, implement one or more of the various functions described herein. In various arrangements, one or more of the modules are a component of the processor(s) 312, or one or more of the modules are executed on and/or distributed among other processing systems to which the processor(s) 312 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 336. The automated driving module(s) 336, in at least one approach, receives data from the sensor system 313 and/or other systems associated with the vehicle 100. In one or more arrangements, the automated driving module(s) 336 uses such data to perceive a surrounding environment of the vehicle. The automated driving module(s) 336 determines a position of the vehicle 100 in the surrounding environment and maps aspects of the surrounding environment. For example, the automated driving module(s) 336 determines the location of obstacles or other environmental features including traffic signs, trees, shrubs, neighboring vehicles, pedestrians, etc.

The automated driving module(s) 336 can be configured to determine travel path(s), current autonomous driving maneuvers for the vehicle 100, future autonomous driving maneuvers and/or modifications to current autonomous driving maneuvers based on data acquired by the sensor system 313 and/or another source. In general, the automated driving module(s) 336 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a machine-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more machine-readable media having machine-readable program code embodied, e.g., stored, thereon. Any combination of one or more machine-readable media may be utilized. The phrase “machine-readable storage medium” means a non-transitory storage medium. A machine-readable storage medium may be, for example, but not limited to, an electronic, magnetic, optical, electromagnetic, infrared, or semiconductor system, apparatus, or device, or any suitable combination of the foregoing. A non-exhaustive list of the machine-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a machine-readable storage medium is, for example, a tangible medium that stores a program for use by or in connection with an instruction execution system, apparatus, or device.

Program code embodied on a machine-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
receive a request to hand over artificial intelligence (AI) content generation to a second edge server, AI content is based on generative AI input data from a vehicle AI agent;
extract context data for a handover, the context data indicating a vehicle state, a second edge server state, and a vehicle-server connection state;
predict a handover time of the generative AI input data based on the context data;
distribute the generative AI input data based on a predicted handover time; and
present the AI content through the vehicle AI agent.

2. The system of claim 1, wherein the vehicle state indicates at least one of:
a location of a vehicle;
a speed of the vehicle;
a direction of travel of the vehicle;
a predicted trajectory for the vehicle;
historical travel patterns for the vehicle; or
a latency criteria of the vehicle AI agent.

3. The system of claim 1, wherein the second edge server state indicates at least one of:
an amount of available processing resources of the second edge server; or
a topology for a network to which the second edge server pertains.

4. The system of claim 1, wherein the vehicle-server connection state indicates at least one of:
an available communication bandwidth of a vehicle-server connection;
a received signal strength across the vehicle-server connection; or
a data transmission rate across the vehicle-server connection.

5. The system of claim 1, wherein the machine-readable instruction that causes the processor to distribute the generative AI input data based on the predicted handover time comprises machine-readable instructions that cause the processor to:
generate the AI content at the vehicle AI agent responsive to the predicted handover time being greater than a predetermined value; and
transmit the generative AI input data to the second edge server responsive to the predicted handover time being less than the predetermined value.

6. The system of claim 1, wherein the machine-readable instruction that causes the processor to distribute the generative AI input data based on the predicted handover time comprises machine-readable instructions that cause the processor to, responsive to the predicted handover time being less than a predetermined value:
determine whether there is a coverage discontinuity between a first edge server coverage area and a second edge server coverage area;
adjust generation parameters of a first edge server to complete the AI content generation while a vehicle is in the first edge server coverage area responsive to a detected coverage discontinuity; and
transmit the generative AI input data to the second edge server responsive to a detected coverage continuity.

7. The system of claim 1, wherein the machine-readable instruction that causes the processor to distribute the generative AI input data based on the predicted handover time comprises machine-readable instructions that cause the processor to, when the predicted handover time is less than a predetermined value and there is coverage continuity between a first edge server coverage area and a second edge server coverage area:
determine whether the second edge server has available processing resources greater than a predetermined processing value;
transmit session history and partially-generated AI content to the second edge server responsive to the second edge server having available processing resources greater than the predetermined processing value; and
transmit the partially-generated AI content to the second edge server and block transmission of the session history to the second edge server responsive to the second edge server having available processing resources less than the predetermined processing value.

8. The system of claim 1, wherein the memory further comprises a machine-readable instruction that, when executed by the processor, causes the processor to determine a predetermined value, against which the predicted handover time is compared, based on the generative AI input data and the vehicle AI agent.

9. The system of claim 1, wherein the machine-readable instruction that causes the processor to predict the handover time of the generative AI input data based on the context data comprises a machine-readable instruction that causes the processor to predict the handover time based on machine-learning processing of the generative AI input data and the context data.

10. A non-transitory machine-readable medium comprising instructions that, when executed by a processor, cause the processor to:
receive a request to hand over artificial intelligence (AI) content generation to a second edge server, AI content is based on generative AI input data from a vehicle AI agent;
extract context data for a handover, the context data indicating a vehicle state, a second edge server state, and a vehicle-server connection state;
predict a handover time of the generative AI input data based on the context data;
distribute the generative AI input data based on a predicted handover time; and
present the AI content through the vehicle AI agent.

11. The non-transitory machine-readable medium of claim 10, wherein the vehicle state indicates at least one of:
a location of a vehicle;
a speed of the vehicle;
a direction of travel of the vehicle;
a predicted trajectory for the vehicle;
historical travel patterns for the vehicle; or
a latency criteria of the vehicle AI agent.

12. The non-transitory machine-readable medium of claim 10, wherein the second edge server state indicates at least one of:
an amount of available processing resources of the second edge server; or
a topology for a network to which the second edge server pertains.

13. The non-transitory machine-readable medium of claim 10, wherein the vehicle-server connection state indicates at least one of:
an available communication bandwidth of a vehicle-server connection;
a received signal strength across the vehicle-server connection; or
a data transmission rate across the vehicle-server connection.

14. The non-transitory machine-readable medium of claim 10, wherein the instruction that causes the processor to distribute the generative AI input data based on the predicted handover time comprises instructions that cause the processor to:
generate the AI content at the vehicle AI agent responsive to the predicted handover time being greater than a predetermined value; and
transmit the generative AI input data to the second edge server responsive to the predicted handover time being less than the predetermined value.

15. The non-transitory machine-readable medium of claim 10, wherein the instruction that causes the processor to distribute the generative AI input data based on the predicted handover time comprises instructions that cause the processor to, responsive to the predicted handover time being less than a predetermined value:
determine whether there is a coverage discontinuity between a first edge server coverage area and a second edge server coverage area;
adjust AI content generation parameters of a first edge server to complete the AI content generation while a vehicle is in the first edge server coverage area responsive to a detected coverage discontinuity; and
transmit the generative AI input data to the second edge server responsive to a detected coverage continuity.

16. The non-transitory machine-readable medium of claim 10, wherein the instruction that causes the processor to distribute the generative AI input data based on the predicted handover time comprises instructions that cause the processor to, when the predicted handover time is less than a predetermined value and there is coverage continuity between a first edge server coverage area and a second edge server coverage area:
determine whether the second edge server has available processing resources greater than a predetermined processing value;
transmit session history and partially-generated AI content to the second edge server responsive to the second edge server having available processing resources greater than the predetermined processing value; and
transmit the partially generated AI content to the second edge server and block transmission of the session history to the second edge server responsive to the second edge server having available processing resources less than the predetermined processing value.

17. A method, comprising:
receiving a request to hand over artificial intelligence (AI) content generation to a second edge server, AI content is based on generative AI input data from a vehicle AI agent;
extracting context data for a handover, the context data indicating a vehicle state, a second edge server state, and a vehicle-server connection state;
predicting a handover time of the generative AI input data based on the context data;
distributing the generative AI input data based on a predicted handover time; and
presenting the AI content through the vehicle AI agent.

18. The method of claim 17, wherein distributing the generative AI input data based on the predicted handover time comprises:
generating the AI content at the vehicle responsive to the predicted handover time being greater than a predetermined value; and
transmitting the generative AI input data to the second edge server responsive to the predicted handover time being less than the predetermined value.

19. The method of claim 17, wherein distributing the generative AI input data based on the predicted handover time comprises, responsive to the predicted handover time being less than a predetermined value:
determining whether there is a coverage discontinuity between a first edge server coverage area and a second edge server coverage area;
adjusting AI content generation parameters of a first edge server to complete the AI content generation while a vehicle is in the first edge server coverage area responsive to a detected coverage discontinuity; and
transmitting the generative AI input data to the second edge server responsive to a detected coverage continuity.

20. The method of claim 17, wherein distributing the generative AI input data based on the predicted handover time comprises, when the predicted handover time is less than a predetermined value and there is coverage continuity between a first edge server coverage area and a second edge server coverage area:
determining whether the second edge server has available processing resources greater than a predetermined processing value;
transmitting session history and partially-generated AI content to the second edge server responsive to the second edge server having available processing resources greater than the predetermined processing value; and
transmitting the partially generated AI content to the second edge server and blocking transmission of the session history to the second edge server, responsive to the second edge server having available processing resources less than the predetermined processing value.
